(19) United States
(12) Patent Application Publication
(10) Pub. No.: US 2007/0036363 A1
(43) Pub. Date: Feb. 15, 2007

(54) Electric device, system and method

(75) Inventors: Gerrit Hollemans, Eindhoven (NL); Vincentius Paulus Buil, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINLIJKE PHILIPS ELECTRONICS N.V., Eindhoven (NL)

(21) Appl. No.: 10/572,619

(22) PCT Filed: Sep. 1, 2004
(86) PCT No.: PCT/IB04/51644

§ 371 Date: Mar. 17, 2006

(30) Foreign Application Priority Data
Sep. 22, 2003 (EP) 03103487.9

(51) Int. Cl. H04R 29/00

(52) U.S. Cl. 381/59; 381/58; 381/60

(57) ABSTRACT

An electric device (100) is suitable for use in first orientations (101) and in second orientations (102). The electric device (100) has a first function (103), a second function (104) and a user interface (105) with a first part (106) and a second part (107). In response to activating either of the parts (106), (107), one of the functions (103), (104) is performed by the electric device (100). To achieve a more consistent user interface (105), the mapping from part activated to function performed is adapted in dependence upon an orientation in use. The orientation in use is detected with a detector (108) comprising a gravity sensor (109). The gravity sensor (109) can contribute to distinguishing left from right and inside in from inside out.

The invention relates to an electric device suitable for use in first orientations and in second orientations.

The invention also relates to an entertainment system.

The invention also relates to a method of adapting a user interface.

An electric device suitable for use in first orientations and in second orientations is known from JP-2002135887A. This document discloses headphone equipment suitable for being worn on a human head. The equipment has a left housing and a right housing and a head strap connecting the left housing with the right housing.

The equipment can be used in first orientations where the left housing covers the left ear of a human head and the right housing covers the right ear. The equipment can also be used in second orientations where the left housing covers the right ear of the human head and the right housing covers the left ear.

The equipment produces a sound in the left housing with a left diaphragm. The equipment produces another sound in the right housing with a right diaphragm. The left and the right diaphragm may each be a voice coil speaker.

The equipment transduces a first electric signal into the sound in the left housing upon activation with the first electric signal. The equipment transduces a second electric signal into the other sound in the right housing upon activation with the second electric signal.

The user may get confused about the left and the right housing, because the equipment can be worn in both the fast orientations and the second orientations. The human body has a substantial left/right symmetry, which, in conjunction with the substantially symmetrical equipment, contributes to the likelihood of confusion.

The likelihood of confusion is further amplified because, with respect to the user, the position of the left diaphragm is substantially the same as the position of the right diaphragm, with the equipment being in use in one of the first or one of the second orientations, respectively.

The equipment has an earlobe detector for detecting an orientation in use from the first orientations and the second orientations.

In dependence upon the orientation detected, the equipment operates a switch that reverses the first electric signal and the second electric signal being fed to the left diaphragm and the right diaphragm, respectively. This has the benefit of an improved consistency in use, because the left ear receives the sound of the first electric signal with the equipment in use in either of the first orientations or the second orientations.

It is a disadvantage of the known equipment that the presence of the earlobe detector limits the size and the position in use of the equipment. The earlobe detector does not apply to, for example, small in-ear type devices. Also, the distance in use between the detector and the earlobe is limited in order to properly detect the earlobe.

It is a first object of the invention to provide an electric device suitable for use in first orientations and in second orientations, which has a detector that, in use, can be distant from the earlobe.

It is a second object of the invention to provide an electric system, comprising an electric apparatus for processing at least one from an audio signal and a video signal, and a remote control for remotely controlling the processing, which has a remote control that, in use, can be distant from the earlobe.

It is a third object of the invention to provide a method for adapting a user interface of an electric device for use in first orientations and in second orientations which can be executed at a distance from the earlobe.

The first object is realized in that the electric device has a first function and a second function, with a user interface having a first part and a second part, a detector comprising a gravity sensor for detecting, in use, an orientation selected from the first and the second orientations, the device being arranged to:
perform, in response to either of the first orientations detected by the detector:
   the first function in response to the first part being activated; and
   the second function in response to the second part being activated; and
perform, in response to either of the second orientations detected by the detector:
   the second function in response to the first part being activated; and
   the first function in response to the second part being activated.

Since there is gravity everywhere on earth, the detector can be used at a distance from the earlobe.

The gravity sensor may be based, for example, on a mechanical switching element. One example of a mechanical switching element has a first contact point and a second contact point, and a pendulum with a third contact point. Each contact point is made of a conductive material. The first contact point and the second contact point are both fixed with respect to the sensor. Dependent on an orientation of the sensor with respect to the gravity force on the pendulum, the pendulum closes an electric circuit between the third contact point and the first contact point when detecting any of the first orientations, or the pendulum closes another electric circuit between the third contact point and the second contact point when detecting any of the second orientations. Other examples of the mechanical switching element are: a metal ball enclosed in a cavity having contact points, and a conductive fluid enclosed in a chamber having contact points.

The gravity sensor may alternatively be based on an optical switching element. The optical switching element comprises a light source emitting rays of light, a movable part for modulating at least some of the rays in dependence upon the orientation, and a photoelectric sensor for sensing the modulated rays of light and for converting the modulation into an electric signal at an output. The source, the part and the sensor are arranged in such a way that the output conveys a first electric signal when any of the first orientations is detected, but the output conveys a second electric signal when any of the second orientations is detected.

There are no extraordinary requirements for the gravity sensor so that, alternatively, many known gravity sensors can be applied.

The sensor may measure at least one angle between an axis of the device and gravity. The at least one angle may be measured with a relatively fine resolution of, say, one degree. The detector may classify the at least one angle into either of two sets or ranges which correspond to the first orientations and the second orientations, respectively. When a plurality of angles is measured, the detector may classify in dependence upon the plurality of angles.

The detector may detect in dependence upon a history of the gravity sensed. This may prevent a short glitch in the user interface when the orientation of the device changes relatively rapidly. The detector may comprise filter means to achieve this. The filter means may be based on mechanical components, analog electric components or digital electric components. Examples of components are springs, dampers, masses, fluids, gases, capacitors, inductors, resistors, A/D converters, logic gates and processors.

The electric device may be an entertainment device, a media player or a communication device for playing content from a medium. The device may additionally capture further content and store or dispatch the further content onto the medium. The electric device may be alternatively a computer device for input, for output, or for input and output. The electric device may be, for example, a walkman, a Discman, a DVD-player, an MP3-player, a baby-phone, a walkie-talkie, a mobile phone, a radio, a television, a monitor, a personal digital assistant (PDA), a pocket computer, a handheld computer, or a smartphone. The content may be audio, video, or multi-media and the like. The medium may be a wired or a wireless connection to a source of the content, or it may be a storage device based on a magnetic medium, a solid-state medium, or an optical medium. Examples of the medium are a radio connection, an Internet connection, a hard disk drive, a memory stick, a compact disc (CD), a digital versatile disc (DVD), or a SuperAudio CD (SACD).

The invention does not only apply to electric devices having a first function of producing a sound in a left housing and a second function of producing another sound in a right housing. Upon being performed, the first function and the second function of the device may change the content being played or change playing the content. Examples are jumping to a subsequent or a previous track of the medium, selecting another station or preset, increasing or decreasing a parameter like a volume level, a treble level or a bass level, responding to an event, accepting or rejecting a telephone call, or selecting a meeting time.

The invention does not only apply to the first orientations and the second orientations of headphone equipment on a human head. The word orientation is taken in a broad sense. It may pertain to a position or a rotation of the device or to a combination of the position and the rotation. The position and the rotation may both be relative to a person using the device or with respect to other surroundings of the device. The device may be portable or wearable, but may alternatively be stationary. The position may pertain, for example, to the body of the person. The device is suitable for use on a head, an eye, an ear, a neck, a chest, a waist, or on either of the extremities such as a leg, an ankle, a hip, a foot, a toe, a shoulder, an upper arm, a lower arm, a wrist, a hand, or a finger. The rotation may pertain, for example, to an angle of the device relative to gravity or relative to the person. The device is suitable for use at a tilt angle, a left side, a right side, upright, upside down, or swiveled. The orientation may also pertain to the first part and to the second part. The orientation may also pertain to a state of the device like being inside out, for example, a wearable device integrated into clothing.

The invention does not only apply to electric devices having a user interface with a first part being a left diaphragm and a second part being a right diaphragm. Alternatively, each part of the user interface has other sensors or actuators for activation. Examples are buttons, micro-switches, touch sensors, joysticks, pointing devices, mice, trackballs, keyboards, touch-sensitive areas, touch pads, tap sensors, tablets, touch-sensitive display screens activated with a stylus or a finger, scanners, cameras or charge-coupled devices, speech recognizers, buzzers, speakers, light bulbs, or light-emitting diodes.

In use, the detected orientation influences the mapping from the activated part to the performed function. If either of the first orientations is detected, the first function is performed in response to the first part being activated, and the second function is performed in response to the second part being activated. If, however, either of the second orientations is detected, the first function is performed in response to the second part being activated, and the second function is performed in response to the first part being activated. This contributes to a consistency in operating the device.

The first orientations may be a mirror image of the second orientations, and the mirror plane may be substantially vertical. This fits in well with a ubiquitous type of symmetry, namely left/right symmetry. This type of symmetry naturally arises from the shape of the human body, as it has a substantially vertical symmetry plane when in an upright position.

The orientation may pertain to the first part and the second part. In one of the first orientations, the first part may thus be a mirror image of the second part in one of the second orientations. The first part and the second part may be on opposite sides of the mirror plane. The orientation may pertain to positions relative to the user of the first and the second part. In an example of that case, the relative position of the first part is substantially the same as the relative position of the second part, the device being in use in one of the first or one of the second orientations, respectively.

The device may comprise a first audio transducer and a second audio transducer. In the first function, a first electric signal is transduced by the first audio transducer and in the second function, a second electric signal is transduced by the second audio transducer. Interchanging the first and the second electric signals when appropriate prevents a so-called reversed left/right stereo picture. The device may comprise further audio transducers that can be interchanged accordingly, for obtaining the proper spatial sound picture. Examples are home cinema systems, and Dolby surround sound systems.

The device may comprise a substantially disc-shaped portion shaped to fit in the concha of a human ear and comprising an audio transducer, and a protruding portion extending laterally from the disc-shaped portion and suitable for carrying a conductive wire to the audio transducer. This device has the advantage of being particularly convenient. When being worn comfortably in the concha, the protruding portion usually points substantially towards the front of the wearer. The disc-shaped portion has an axis in a plane. The protruding portion is also substantially in the plane. One example of a gravity detector for this device has a strip of conductive material. The strip is connected to the device with a hinge having an axis in the plane. The gravity sensor comprises a first and a second set of contact points, with the plane in between the first and the second set. Each contact point is made of a conductive material. The strip closes electric circuits in dependence upon an orientation of the sensor with respect to the gravity force on the strip. The strip closes an electric circuit with the contact points of the first set when detecting any of the first orientations. The strip closes another electric circuit with the contact points of the second set when detecting any of the second orientations.

The device may additionally have at least another protruding portion for e.g. guiding a sound from the transducer inside the auditory canal. The other protruding portion may enhance, for example, sound quality.

Another refinement is that the device may have a further function and control means for controlling the further function. Apart from providing stereophonic sound, the device may be equipped with sensors for operating the device. One example of such a device is a pair of earpieces or earbuds, where each earpiece can be worn on the left ear and on the right ear, and where each earpiece has a sensor, for example, a touch-sensitive area or a plain button. The sensor of one earpiece serves to increase a setting, while the sensor of the other earpiece serves to decrease the setting. A media player may jump, for example, to the previous track, in response to an activation of the button of an earpiece inserted in the left ear, regardless of whether the one or the other earpiece was inserted in the left ear.

In another embodiment, the device comprises an audio transducer with a loudness level in a range of loudness levels, the first function being an increase of the loudness level in the range of loudness levels, the second function being a decrease of the loudness level in the range of loudness levels. One example of such a device is a so-called headset with boom, comprising a main piece and a rod-shaped piece carrying a microphone on the end that is close to the mouth when the headset is being worn. The main piece can be clipped to either the left ear or the right ear and has a control for increasing the loudness and another control for decreasing the loudness. The user interface is improved by interchanging the functionality of the buttons when being worn on a left ear, as it ensures that the button for increasing the loudness is always in one of two pairs of mirrored positions relative to the user. Alternatively to an audio volume level or loudness level, other properties of audio signals may be controlled in this way.

The detector may comprise a further sensor and the detector may be arranged to detect, in use, an orientation in dependence upon both the gravity sensor and the further sensor. The further sensor can enhance the precision of detecting the orientation. The further sensor may be a further gravity sensor, but it may also be some other sensor like a touch sensor, a proximity sensor, an acceleration sensor, a temperature sensor, an image sensor or any other sensor that may contribute to detecting the orientation of the device. One example is a further gravity sensor mounted at an angle with respect to the gravity sensor.

Another example is a device comprising at least two units. Each of the at least two units is worn by the user at a respective orientation relative to the user. At least two of the at least two units of the device each comprise a sensor. The plurality of sensors can enhance detecting an orientation in use, in that multiple orientations of the device can be distinguished. The device may be additionally suitable for use in third orientations, and, in response to detecting any of the third orientations, may perform neither the first nor the second function, despite either of the first and the second part being activated.

Yet another example is a device with a first unit being a media player and a second unit being a set of two earpieces. The media player is worn with a headband on the head, or a belt around the chest, the waist or the hips of the user. The set of two earpieces is worn in the ears of the user, one earpiece in each ear. The first unit has a gravity sensor, and the second unit has a further sensor. The gravity sensor may detect the head or the trunk of the user e.g. lying on his back, bending over to the front, or being upside down. Detecting an orientation in use in dependence upon both the gravity sensor and the further sensor can further enhance the consistency of the user interface for relatively rare poses of the user.

In an embodiment, the user interface is integrated with a piece of clothing. This has the benefit that it can improve comfort in operating and wearing the device. Also, some clothing may be worn inside out while maintaining the benefit of an improved consistency of the user interface of the device. Examples of clothing are hats, caps, headbands, shawls, sashes, necklets, coats, jackets, tops, shirts, belts, waistbands, trousers, skirts, or anklets.

A cap with a front flap may have, for example, the first and the second part on a left and a right side of the flap, respectively. The cap may be worn inside in or inside out. The orientation in use may be detected with a gravity sensor located, for example, at the back of the cap.

A coat may have, for example, the first and the second part on its sleeves or on the left and the right side of its collar or body, respectively. The coat may be worn inside in or inside out. The orientation in use may be detected with a gravity sensor located, for example, in a shoulder part.

A belt may have, for example, the first and the second part near the buckle and further away from the buckle along the belt, respectively. The belt can be threaded around the waist clockwise or counter-clockwise. The orientation in use may be detected with a gravity sensor located, for example, in the buckle, such that e.g. a volume can be decreased with a button close to the left hip, regardless of the way the belt was threaded.

A substantially cylindrical headband with a main axis may have, for example, the first part and the second part on diametrically opposing locations along the headband. The headband may be worn upside down, inside out, rotated around the head, or combinations thereof. The orientation in use may be detected with a gravity sensor and a further sensor. The gravity sensor detects the headband being worn upside down in dependence upon gravity pointing towards a side of a main plane perpendicular to the main axis. The gravity sensor detects the headband being worn rotated half a turn around the head in dependence upon gravity pointing towards a side of a plane perpendicular to a radian from the main axis to the gravity sensor. The further sensor detects the headband being worn inside out. The further sensor may be sensing a temperature gradient radial through the headband or may be sensing the headband being touched or curved inside or outside along the headband. The detector is arranged in such a way that e.g. a volume can be decreased with a button close to the left ear, regardless of the way the headband is worn.

The device may monitor a body function of the user. An example is a waistband for monitoring cardiac arrests, having a set of skin sensors that need to be close to the heart for good performance. The waistband has a front but it may be worn upside down, in which case a further set of skin sensors closer to the heart may be selected for monitoring instead of the set. The device may select sensors in dependence upon the detected orientation in use.

The second object is realized in that the remote control comprises an electric device according to the invention. The device according to the invention is particularly suited as part of a remote control for the apparatus of the system. Since there is gravity everywhere on earth, the remote control can be used at a distance from the earlobe, while maintaining an improved consistency of the user interface, because the mapping from activated part to function performed is adapted in dependence upon the orientation of the remote control. Examples include entertainment systems, media players, communication devices and computer devices, described before as examples of the electric device.

The third object is realized in that the user interface has a first part and a second part, the device having a first function and a second function, and the method comprising the steps of:
detecting, in use, an orientation selected from the first and the second orientations comprising the step of sensing gravity,
performing, in response to detecting either of the first orientations:
   the first function in response to activation of the first part; and
   the second function in response to activation of the second part, and
performing, in response to detecting either of the second orientations:
   the second function in response to activation of the first part; and
   the first function in response to activation of the second part.

By comprising sensing gravity, the method can be executed at a distance from the earlobe.

The above object and features of the electric device, the system and the method of the present invention will be more apparent from the following description with reference to the drawings. In the drawings:

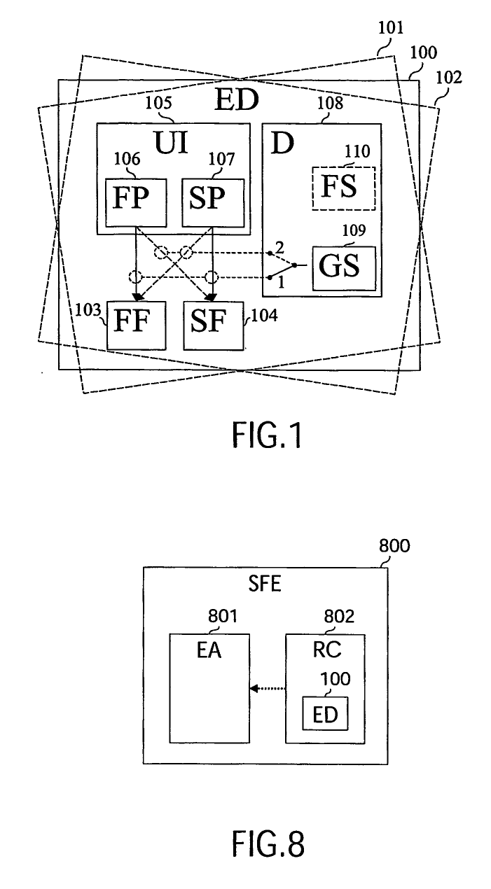

FIG. 1 shows a block diagram of an electric device according to the invention;

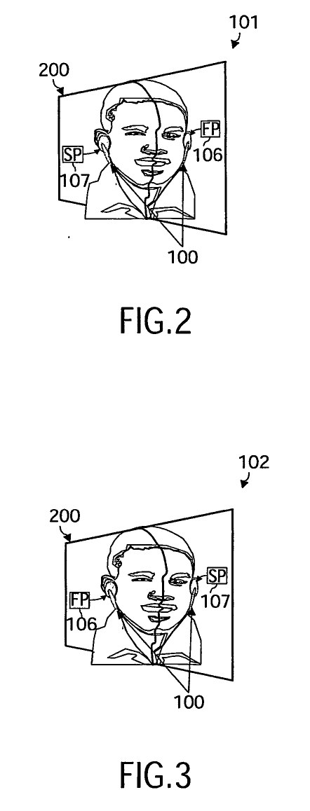

FIG. 2 is a schematic overview of an electric device according to the invention with substantial left/right symmetry being used in one of the first orientations;

FIG. 3 shows the device of FIG. 2 being used in one of the second orientations;

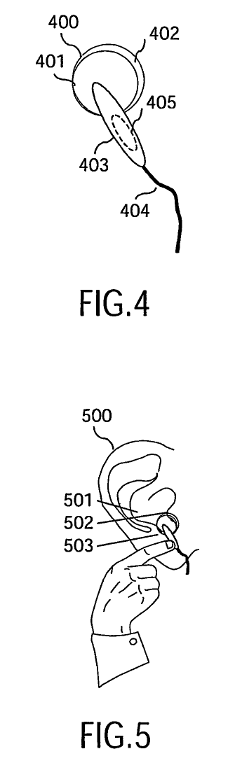

FIG. 4 is a schematic side view of a particularly comfortable electric device according to the invention;

FIG. 5 shows the device of FIG. 4 in use in the right ear of a human;

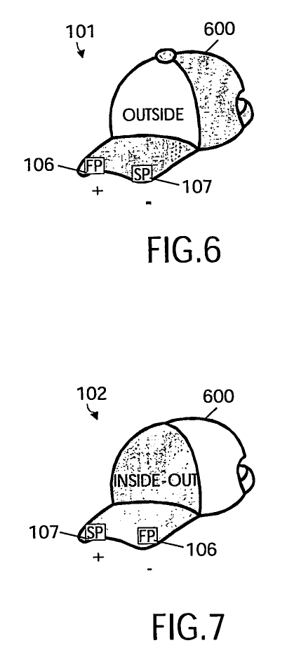

FIG. 6 shows an electric device integrated in clothing according to the invention in one of the first orientations.

FIG. 7 shows the device of FIG. 6 in one of the second orientations.

FIG. 8 shows a block diagram of an entertainment system according to the invention.

Throughout the Figures, same reference numerals indicate similar or corresponding features.

In FIG. 1, the electric device 100 is suitable for use in first orientations 101 and second orientations 102. In an example, the electric device 100 has a left and a right earpiece, see FIG. 2, FIG. 3, FIG. 4 and FIG. 5. The device 100 can be used in first orientations 101 with the left earpiece being inserted in the left ear and the right earpiece being inserted in the right ear, see FIG. 2. Alternatively, the device 100 can be used in second orientations 102 with the left earpiece being inserted in the right ear and the right earpiece being inserted in the left ear, see FIG. 3.

The device 100 has a first function 103 and a second function 104. For the example of the devise 100 with earpieces, the first function 103 is to produce a sound in the left earpiece, and the second function 104 is to produce another sound in the right earpiece.

The device 100 has a user interface 105 having a first part 106 and a second part 107. In the example, the first part 106 is a first voice coil speaker in the left earpiece, wired to a first connector, and the second part 107 is a second voice coil speaker in the right earpiece, wired to a second connector.

The device 100 has a detector 108 comprising a gravity sensor 109 for detecting, in use, an orientation selected from the first and the second orientations.

As indicated in FIG. 1 by arrows, dashed lines and circles, the device 100 is arranged to:
perform, in response to either of the first orientations 101 being detected by the detector 108:
   the first function 103 in response to the first part 106 being activated; and
   the second function 104 in response to the second part 107 being activated; and
perform, in response to either of the second orientations 102 being detected by the detector 108:
   the second function 104 in response to the first part 106 being activated; and
   the first function 103 in response to the second part 107 being activated.

In FIG. 2, the example of the electric device 100 has one of the first orientations 101. The earpieces are worn in the user's ears, one earpiece in each ear. Due to a substantial symmetry of the user with a mirror plane 200, and symmetry between the earpieces, the device can be worn in one of the second orientations, see FIG. 3. The first earpiece has the first part 106 and the second earpiece has the second part 107. The first orientations 101 are a mirror image of the second orientations 102. The mirror plane 200 is substantially vertical.

In FIG. 2 and FIG. 3, the electric device 100 comprises a first audio transducer inside one earpiece and a second audio transducer inside the other earpiece. The user can listen to the proper stereo picture with the sound of a left electric signal in the left ear, regardless of whether the earpieces are worn in the first 101 or in the second orientations 102.

In FIG. 4 and FIG. 5, an electric device 400 comprises a substantially disc-shaped portion 401 shaped to fit in the concha 501 of a human ear 500. The electric device 400 is particularly comfortable in wearing. The disc-shaped portion 401 comprises an audio transducer 402. This may be a voice coil speaker, an electrostatic or a piezo-electric transducer. The device 400 has a protruding portion 403 extending laterally from the disc-shaped portion 401. The protruding portion 403 is suitable for carrying a conductive wire 404 to the audio transducer 402. Typically, the wire couples the transducer 402 to an audio source. When being worn, the protruding portion usually points towards the front of the wearer. Each earpiece has a gravity sensor 109 having a cylindrical cavity with an axis, which encloses a ball of conductive material. The axis is perpendicular to a main axis of the disc-shaped portion 401. Moreover, the axis is perpendicular to another main axis of the protruding portion 403. The gravity sensor 109 comprises a first and a second set of contact points, each on one end of the cavity. Each contact point is made of a conductive material. The ball closes an electric circuit between the contact points of the first set if the earpiece is in one of the first orientations 101. The ball closes another electric circuit between the contact points of the second set if the earpiece is in one of the second orientations 102. The voice coil speaker can be wired with one side to both a contact point of the first and a contact point of the second set. The other contact points of the first and the second set are wired to the first and the second electric signal, respectively. The other side of the voice coil speaker is wired to a common ground of the first and the second electric signal.

In FIG. 4, the device 400 has a further function and control means 405 for controlling the further function. In addition to converting an electric signal on the wire 404 into sound, the earpiece 400 may offer a control 405 for controlling a source of the electric signal.

The device 400 has an audio transducer 402 with a loudness level in a range of loudness levels, the first function 103 being an increase of the loudness level in the range of loudness levels, the second function 104 being a decrease of the loudness level in the range of loudness levels. With two earpieces 400, this provides an attractive user interface. The sensor of the earpiece worn left serves to decrease the loudness level, and the sensor of the earpiece worn right serves to increase the loudness level, also after interchanging the earpieces.

In FIG. 6 and FIG. 7, the user interface 105 is integrated with a piece of clothing 600, being a cap with a front flap comprising the parts 106, 107 of the user interface. Touching, tapping, or pinching the flap at the location of either of the parts activates the respective part. If the cap is worn inside out as in FIG. 7, the parts change places, but the coupled functions do not change places, as is indicated by a plus and a minus symbol in FIG. 6 and FIG. 7.

In FIG. 1, the detector 108 may comprise a further sensor 110. The detector 108 can be arranged to detect, in use, an orientation in dependence upon both the gravity sensor 109 and the further sensor 110. This may further improve the consistency of the user interface as the detector may properly take less ordinary poses of the user into account. An example is a further gravity sensor 110 worn on the back of the user for detecting the user being upside down and interchanging the first and the second function in response to detecting the user being upside down.

In FIG. 8, an entertainment system 800 comprises an electric apparatus 801 and a remote control 802. The electric apparatus 801 processes an audio signal, a video signal or both an audio signal and a video signal. The remote control 802 may be used to remotely control the processing. The remote control 802 comprises an electric device 100 according to the invention.

It is noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verbs “have” or “comprise” and their conjugations does not exclude the presence of elements or steps other than those stated in a claim. The article “a” or “an” preceding an element does not exclude the presence of a plurality of such elements or steps. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. An electric device (100) suitable for use in first orientations (101) and in second orientations (102), having a first function (103) and a second function (104), with a user interface (105) having a first part (106) and a second part (107), a detector (108) comprising a gravity sensor (109) for detecting, in use, an orientation selected from the first and the second orientations, the device being arranged to:
perform, in response to either of the first orientations (101) being detected by the detector (108):
the first function (103) in response to the first part (106) being activated; and
the second function (104) in response to the second part (107) being activated; and
perform, in response to either of the second orientations (102) being detected by the detector (108):
the second function (104) in response to the first part (106) being activated: and
the first function (103) in response to the second part (107) being activated.

2. An electric device (100) as claimed in claim 1, wherein the first orientations (101) are a mirror image of the second orientations (102), the mirror plane (200) being substantially vertical.

3. An electric device (100) as claimed in claim 1, comprising a first audio transducer and a second audio transducer, the first function (103) being transducing a first electric signal by the first audio transducer and the second function (104) being transducing a second electric signal by the second audio transducer.

4. An electric device as claimed in claim 1, comprising:
a substantially disc-shaped portion (401) shaped to fit in the concha (501) of a human ear (500) and comprising an audio transducer (402); and
a protruding portion (403) extending laterally from the disc-shaped portion (401), suitable for carrying a conductive wire (404) to the audio transducer (402).

5. An electric device (400) as claimed in claim 4, having a further function and having control means (405) for controlling the further function.

6. An electric device as claimed in claim 1, comprising an audio transducer with a loudness level in a range of loudness levels, the first function (103) being an increase of the loudness level in the range of loudness levels, the second function (104) being a decrease of the loudness level in the range of loudness levels.

7. An electric device as claimed in claim 1, wherein the detector (108) comprises a further sensor (110) and the detector (108) is arranged to detect, in use, an orientation in dependence upon both the gravity sensor (109) and the further sensor (110).

8. An electric device as claimed in claim 1, wherein the user interface (105) is integrated with a piece of clothing (600).

9. An entertainment system (800), comprising:
an electric apparatus (801) for processing at least one from an audio signal and a video signal, and
a remote control (802) for remotely controlling the processing, comprising an electric device (100) as claimed in claim 1.

10. A method of adapting a user interface (105) of an electric device (100) for use in first orientations (101) and in second orientations (102), the user interface (105) having a first part (106) and a second part (107), the device (100) having a first function (103) and a second function (104), the method comprising the steps of:
detecting, in use, an orientation selected from the first (101) and the second orientations (102) comprising the step of sensing gravity (109),
performing, in response to detecting either of the first orientations (101):
the first function (103) in response to activation of the first part (106); and
the second function (104) in response to activation of the second part (107), and
performing, in response to detecting either of the second orientations (102):
the second function (104) in response to activation of the first part (106); and
the first function (103) in response to activation of the second part (107).
